(19) United States
(12) Patent Application Publication
(10) Pub. No.: US 2015/0302553 A1
(43) Pub. Date: Oct. 22, 2015

(54) METHOD AND APPARATUS FOR DETERMINING SOURCE RESOLUTION OF SCALED IMAGES

(71) Applicant: THOMSON LICENSING, Issy de Moulineaux (FR)

(72) Inventor: Pierre Hugues ROUTHIER, Los Angeles, CA (US)

(21) Appl. No.: 14/620,977

(22) Filed: Feb. 12, 2015

Related U.S. Application Data
(60) Provisional application No. 62/003,594, filed on May 28, 2014.
(60) Provisional application No. 61/954,175, filed on Mar. 17, 2014.

(51) Int. Cl. G06T 3/40; G06K 9/62

(52) U.S. Cl. CPC G06T 3/40; G06K 9/6202

(57) ABSTRACT

A method for determining whether an incoming image constitutes an up-scaled version of a lower resolution source image commences by first selecting a suspected resolution for the source image. The incoming image undergoes de-scaling to the suspected resolution. Thereafter, the incoming image is re-scaled after de-scaling without increasing image detail from the scaled down iteration The image detail of the re-scaled incoming image is compared with the image detail of the source image to determine whether the incoming image (as de-scaled and then re-scaled) has comparable detail to the source image. When the re-scaled image has substantially the same detail as the source image, the source image has the suspected image resolution. If the re-scaled image has inferior detail to the source image, the source image has a higher resolution.

### CROSS-REFERENCE TO RELATED APPLICATIONS

This application claims priority under 35 U.S.C. 119(e) to U.S. Provisional Patent Application Ser. No. 61/954,175, filed Mar. 17, 2014, the teachings of which are incorporated herein.

### TECHNICAL HELD

The present principles relate to detecting image scaling.

### BACKGROUND ART

The ability to determine automatically the resolution of a source image can prove useful in various different fields. For example, knowing the source resolution in connection with visual effects processing could avoid superfluous render time by rendering effects in accordance with the resolution of the source footage. Knowing the source resolution aids in image forensics by assisting in identifying the device that captured the image. Additionally, knowing the source resolution facilitates quality control by ensuring that a vendor required to provide images in a specified resolution does not provide lower quality images

Presently, no simple methods currently exist that enable an operator to determine automatically the original resolution of a scaled image. Thus, a need exists for a technique for determining the original image resolution that overcomes this disadvantage.

### BRIEF SUMMARY

Briefly, in accordance with an aspect of the principles, detection of whether an incoming image constitutes an up-scaled version of a lower resolution source image commences by first selecting a suspected native resolution for the source image. The incoming image undergoes de-scaling to the suspected native resolution. Thereafter, the incoming image is re-scaled after de-scaling without increasing image detail. The image detail of the re-scaled incoming image is compared with the image detail of the source image to determine whether the incoming image (as de-scaled and then re-scaled) has comparable detail to the source image. When the re-scaled image has substantially the same detail as the source image, the source image has the suspected image resolution. If the re-scaled image has inferior detail to the source image, the source image has a higher resolution.

The above-described process can undergo successive iterations using successively higher values for the suspected resolution in order to determine the actual resolution of the source image. Thus, the method of the present principles not only determines whether an image has undergone scaling, but also can determine the native resolution of the source image prior to scaling.

### BRIEF SUMMARY OF THE DRAWING

FIG. 1 illustrates a block schematic diagram of a system for determining whether an incoming image constitutes an up-scaled version of a lower resolution source image in accordance with the present principles.

### DETAILED DESCRIPTION

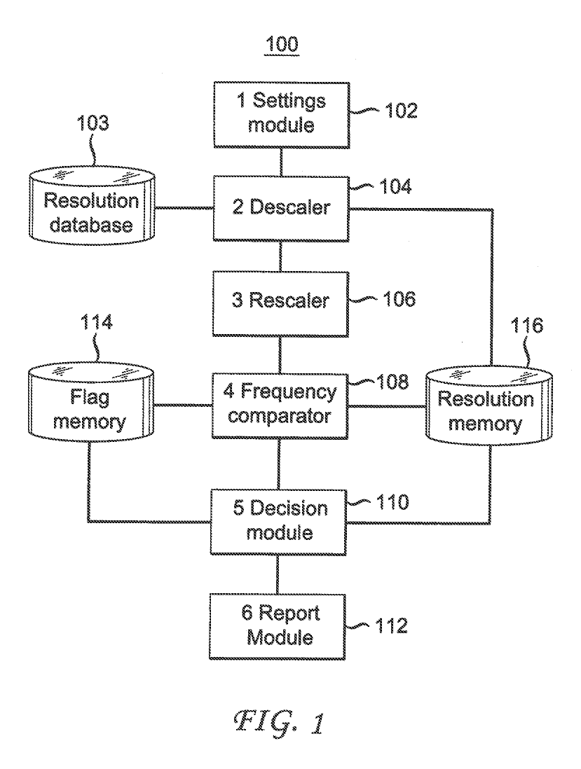

FIG. 1 illustrates block schematic diagram of a system 100 for determining whether an incoming image constitutes an up-scaled version of a lower resolution source image in accordance with the present principles. A described herein after, the system 100 makes such a determination using the level of detail in the source image as a benchmark in determining the actual resolution of the source image from which the incoming image was derived. As discussed hereinafter, the system 100 makes use of the Peak Signal-to-Noise Ratio (PSNR) of the incoming image to determine the true resolution of the source image by a succession of comparisons to alternate resolutions. Alternatively, a comparative detail analysis method other than peak PSNR could be used to make that determination.

The system 100 of FIG. 1 typically comprises a programmed computer and/or a combination of one or more logic circuits, which perform the functions described hereinafter with respect to the following the modules: (1) Settings Module 102, (2) Descaler Module 104, (3) Rescaler Module 106, (4) Frequency Comparator Module 108, (5) Decision Module (110) and, (6) Report Module (112).

### 1. Settings Module 102

The setting module 102 enables an operator to a select an incoming image for analysis and optionally select at least one suspected resolution for the source image from which the incoming image was derived in order to determine the actual resolution of that source image. For example, the operator could choose 1920 pixels by 1080 pixel as the suspected resolution of the source image. The operator could readily choose another value such as 720 pixels by 480 pixels. If the operator does not choose a suspected resolution, the Settings Module 102 of the system 100 will select a value for the suspected resolution. In practice, when the operator has not entered a suspected resolution for the source image, the setting module 102 will typically choose a suspected resolution that constitutes a next lower standard resolution than the purported resolution of the incoming image. In selecting a suspected resolution, the settings module can access a database 103 storing such resolution values. In the case where the comparison includes resolutions in a different aspect ratio (ex.: 4:3 versus 16:9), the system will maintain the source aspect ratio and process a cropped image within the compared resolution. For example, comparing 1920×1080 to 720×480, the system would scale down the 1920×1080 image to 720×480 to maintain the proper aspect ratio.

### 2. Descaler Module 104

The Descaler Module 104 descales, that is scales down, the incoming image to the suspected resolution set by the Settings Module 102; either the operator-selected value or the default value as discussed above. The descaling of the incoming image by the Descaler Module 102 has the effect of reducing the level of detail in the incoming image to the level of the detail of the suspected resolution by reducing pixels and thus, image detail.

### Rescaler Module 106

The Rescaler Module 106 rescales the incoming image descaled by the Descaler Module 104 to the original initial size of the incoming using a method that does not increase the level of detail within that image. For example, the Rescaler Module 104 could perform bi-cubic filtering of the incoming image to accomplish such rescaling. Rather than use bi-cubic filtering, the Rescaler Module 104 could use other well-known techniques that accomplish rescaling without adding image detail.

### 4. Frequency Comparator Module 106

The Frequency Comparator module 108 compares the level of detail in the incoming image, after descaling and now resealing, to the level of detail in the source image from which the incoming image was derived. The Frequency Comparator module 108 uses the global Peak Signal-to-Noise-Ratio (PSNR) of these two images to make such a comparison. The PSNR refers to the ratio of the maximum possible power of a signal representing an image and the power of the noise that affects the fidelity of the image signal. Various methodologies exist in the art for calculating the Peak Signal-to-Noise-Ratio (PSNR) of images. Making a partial identification of the PSNR within the images will generally not yield useful results because of factors such as motion blur, depth of field or compression artifacts can adversely affect the PSNR, Using the global peak PSNR for the images reduces the influence of such factors. Alternatively, other comparative methods to analyze detail can be used, like Structural Similarity (SSIM).

### Decision Module 110

The Decision Module 110 makes use of the comparison of the image detail made by the Frequency Comparator module 108 to determine whether the incoming image, after descaling and subsequent resealing, has a level of detail inferior to that of the source image from which the incoming image was derived. If the Decision Module 110 determines that the descaled and resealed incoming image has an inferior level of detail, then the source image has a higher resolution. The comparison level can set by an operator, say a 10% difference between the two images in order for the two images to have comparable or substantially the same resolution. The Decision Module 110 system will set a Flag Memory 116 to indicate that incoming image has an inferior level of detail. Further, the Decision Module 110 will increase the suspected resolution value to the next higher value and update the Resolution Memory 116 with this new resolution value before performing this analysis again.

If the Decision Module 110 determines that the level of detail of the descaled and resealed incoming image substantially matches the level of detail of the source image (e.g., a 10% difference or less), the Decision Module will set a flag in the Flag Memory 114 to indicate identification of the source image resolution and that the source image constitutes an inferior image, Now, the Decision Module 110 has completed its analysis and sends the value of the current resolution to the Report Module 112. The system 100 now resets the Flag Memory, 114 and the Resolution Memory 116.

If the Decision Module 110 determines that the level of detail of the descaled and rescaled incoming image equals the level of detail of the source image on a first iteration, (i.e. the Flag Memory 114 has no set flags), then, the source image has equal or inferior resolution to the suspected resolution set by the Setting Module 102. The Decision Module 110 of the system 100 will set a flag in the Flag Memory 114 to indicate it found an “equal” source image. Thereafter, the Decision Module 110 will select the next resolution below the previous value for the suspected resolution and then update the Resolution Memory 116. The system 100 then performs the analysis again with the new lower resolution.

If the Decision Module 110 determines the descaled and rescaled incoming image has a level of detail inferior to the source image, and a flag signaling an equal image appears set in the Flag Memory 114, then the Decision Module will identify the resolution of the source image as equal to the current value of the suspected resolution. The Decision Module 110 has now completed its analysis and sends the value of the resolution of the source image to the Report Module 112 before resetting the Flag Memory 114 and the Resolution Memory 116.

### 6. Report Module 112

The Report Module 112 receives information from the Decision Module 110 for reporting to the operator. Thus, the Report Module 112 will report to the operator the resolution of the incoming image and the resolution of the source image determined by the Decision Module 110 in the manner as discussed above. To this end, the Report Module 112 typically has the ability to interface with a visual display device (not shown) to provide the operator with a visual display of such resolution information. Further, the Report Module 112 could possess the ability to interface with one or more networks, whether wired or wireless, to communicate the resolution information to the operator over such network(s).

The Report Module 112 has the ability to report the resolution as well as related information in a variety of different contexts. As described, the Report Module 110 can display the resolution information graphically. Further, the Report Module 110 could present the resolution information periodically in the form of a log along with the time at of generation of each resolution value. Further, the Report Module 110 could report the time required to perform analysis as well as other useful data.

As discussed above, the present principles makes use of standard resolution values to determine whether an incoming image constitutes an up-scaled version of a lower resolution source image, as well as determining the actual resolution of the source image. Using standard resolution value in an iterative provides a good balance of accuracy and speed. Standard resolution values include at least the following listed in Table I below

TABLE 1
1920 × 1080
1280 × 720
720 × 480

In the event of a need for very high precision, the 100 system could, as an optional mode, use finer increments of resolution, selected by the user (i.e. reduction of size of one pixel at a time, 5 pixels at a time, etc. . . . ) to find the exact resolution of the source. Using finer increments of resolution would naturally lead to a much larger number of iterations and potentially long computing times, but may be necessary in the case of forensics, for example. Alternatively, the system 100 could employ a hybrid approach, beginning with a library of standard resolutions, and then switching to an ultra-precision mode with finer resolution increments when the system identifies a resolution requiring higher precision.

1. A method for detecting whether an incoming image is a scaled version of a source image from which the incoming image was derived; comprising,
descaling the incoming image to a suspected resolution;
resealing the descaled incoming image without increasing image detail; and
comparing image detail in the resealed incoming image with image detail of the source image to determine whether the resealed incoming image has comparable image detail to the source image.

2. The method according to claim 1 further including the step of reporting to an operator results of comparing image detail in the resealed incoming image with image detail of the source image.

3. The method according to claim 2 wherein the results are reported visually.

4. The method according to claim 2 wherein the reporting step includes reporting that the source image has substantially the same resolution as the suspected resolution when the resealed incoming image has substantially the same detail as the source image.

5. The method according to claim I wherein the step of comparing image detail in the resealed incoming image with image detail of the source image includes:
establishing a Peak Signal-to-Noise Ratio (PSNR) for the resealed incoming image and the source image; and
comparing the PSNR of the resealed incoming image and the PSNR of the source image.

6. The method according to claim 5 wherein the PSNR comprises a global PSNR for each image.

7. The method according to claim 1 where the comparing image detail in the resealed incoming image with image detail of the source image occurs using Structural Similarity.

8. The method according to claim 1 wherein the suspected resolution is set in accordance with an operator entered value.

9. The method according to claim 1 wherein the suspected resolution in set in accordance with a default value.

10. The method according to claim 1 wherein the suspected resolution comprises a standard resolution value.

11. The method according to claim 1 wherein the suspected resolution comprises one of a standard resolution value or an incremental resolution value.

12. Apparatus for detecting whether an incoming image to a source image from which the incoming image was derived; comprising,
a settings module for setting a suspected resolution for the source image;
a descaling module for descaling the incoming image to the suspected resolution;
a resealing module for resealing the descaled incoming image without increasing image detail; and
a comparing module for comparing image detail in the resealed incoming image with image detail of the source image to determine whether the resealed incoming image and has comparable image detail with the source image.

13. The apparatus according to claim 12 further including a reporting module for reporting to an operator results of comparing image detail in the resealed incoming image with image detail of the source image.

14. The apparatus according to claim 13 wherein the reporting module reports that the source image has the same resolution as the suspected resolution when the resealed incoming image has the same detail as the source image.

15. The apparatus according to claim 12 wherein the comparing module compares the image detail in the rescaled incoming image with image detail of the source image by (a) establishing a Peak Signal-to-Noise Ratio (PSNR) for the rescaled incoming image and the source image; and (b) comparing the PSNR of the resealed incoming image and the PSNR of the source image.

15. The apparatus according to claim 14 wherein the PSNR comprises a global PSNR for each image.

16. The apparatus according to claim 12 wherein the comparing module compares the image detail in the rescaled incoming image with image detail of the source image using Structural Similarity.

17. The apparatus according to claim 12 wherein settings module sets the suspected resolution in accordance with an operator entered value.

18. The apparatus according to claim 12 wherein the suspected resolution in set in accordance with a default value.

19. The apparatus according to claim 12 wherein the suspected resolution comprises a standard resolution value.

20. The apparatus according to claim 12 wherein the suspected resolution comprises one of a standard resolution value or an incremental resolution value.
